(19) United States
(12) Patent Application Publication
(10) Pub. No.: US 2016/0034589 A1
(43) Pub. Date: Feb. 4, 2016

(54) METHOD AND SYSTEM FOR SEARCH TERM WHITELIST EXPANSION

(71) Applicant: Alibaba Group Holding Limited, George Town (KY)

(72) Inventors: Qing Liu, Hangzhou (CN); Wenjun Zhou, Hangzhou (CN); Hua Huang, Hangzhou (CN)

(21) Appl. No.: 14/811,498

(22) Filed: Jul. 28, 2015

(30) Foreign Application Priority Data
Jul. 30, 2014 (CN) 201410370143.1

(51) Int. Cl. G06F 17/30

(52) U.S. Cl. CPC G06F 17/30867; G06F 17/3051

(57) ABSTRACT

Expanding of a search term whitelist is disclosed including receiving a search request, the search request being used to instruct a search in a first search system for information related to a term to be searched, retrieving the term to be searched from the search request, determining whether the term to be searched is in a search term whitelist, and in the event that the term to be searched is not in the search term whitelist: computing an attribute value of the term to be searched, determining whether the attribute value of the term to be searched is greater than a preset threshold value, and in the event that the attribute value of the term to be searched is greater than the preset threshold value, adding the term to be searched to the search term whitelist.

### CROSS REFERENCE TO OTHER APPLICATIONS

This application claims priority to People's Republic of China Patent Application No. 201410370143.1 entitled A SEARCH TERM WHITELIST EXPANSION METHOD AND RELATED SYSTEM, filed Jul. 30, 2014 which is incorporated herein by reference for all purposes.

### FIELD OF THE INVENTION

The present application relates to a method and system for search term whitelist expansion.

### BACKGROUND OF THE INVENTION

Through search engines and other search systems, information retrieval services are offered to users. Based on an example where a search system corresponds to search engine A, a typical search process includes the following: after receiving a search request, based on a term to be searched included in the search request, search engine A searches for search results that match the term to be searched.

When search engine A receives a search request transmitted by another search system, for example, search engine B, prior to performing the search, search engine B usually also performs search term whitelist filtering of a term to be searched included in the search request. The typical process includes the following: determining whether the term to be searched included in the search request is in the search term whitelist; in the event that the term to be searched included in the search request is not in the search term whitelist, display null as the search result. This is because if a search of the term to be searched were performed directly without establishing a search term whitelist, a lower relevance of the search results for the term to be searched could result, and search engine B would record the less relevant search results, and thus lower the ranking of search engine A's results in the search results of search engine B.

Currently, the search term whitelist can be expanded. When expanding the search term whitelist, typically, a system log analysis is employed. At predefined intervals, terms to be searched entered by users are analyzed using system log offline data, and determinations are made as to whether to add the terms to the search term whitelist. In this technique, because the search term whitelist is only expanded once every predefined interval, timeliness is quite poor, and a strong possibility exists that a user will be unable to access search engine A from search engine B to perform a search of the term to be searched, resulting in a loss of traffic on search engine A and a less satisfactory user experience.

The above example is an example in which the search system corresponds to a search engine. The above technique is similarly present in other search systems.

### BRIEF DESCRIPTION OF THE DRAWINGS

Various embodiments of the invention are disclosed in the following detailed description and the accompanying drawings.

FIG. 1 is a schematic flow diagram of an embodiment of a process for search term whitelist expansion.

FIGS. 2, 3A and 3B are flowcharts of another embodiment of a process for search term whitelist expansion.

FIG. 4 is a system diagram of an embodiment of a server for search term whitelist expansion.

FIG. 5 is a diagram of an embodiment of a system for search term whitelist expansion.

FIG. 6 is a functional diagram illustrating an embodiment of a programmed computer system for search term whitelist expansion.

### DETAILED DESCRIPTION

The invention can be implemented in numerous ways, including as a process; an apparatus; a system; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Search Engine Optimization (SEO) refers to a technique that utilizes search rules of a search engine to increase a natural ranking of a website (which can be another search engine) in a relevant search engine.

As a process of performing SEO, when search engine A (e.g., a specified intrasite search engine configured to search specific content on a particular website) receives a search request transmitted by search engine B (e.g., a general search engine such as Google® or Baidu® that performs general websearches), before performing the search, a search term whitelist filtering of the term to be searched (also known as a keyword) is performed. The search term whitelist filtering process includes: determining whether a term to be searched in the search request is in the search term whitelist; in the event that the term to be searched in the search request is in the search term whitelist, directly performing a search of the term to be searched and returning the search results; in the event that the term to be searched in the search request is not in the search term whitelist, returning an error (for example, a 404 page not found error). This whitelist is used because if a search of the term to be searched were performed directly without establishing a search term whitelist, results having less relevance of the search results to the term to be searched could result. For example, if the quality of the search term itself is relatively low, or if a competitor maliciously creates garbage keywords, a search page having lower quality will likely be produced by search engine A. To facilitate future searches, search engine B will typically record this search page as having a lower quality, thereby lowering search engine B's scoring of search engine A's results, and thus causing search engine A's results to be penalized by search engine B. In an example of penalization by search engine B, search engine B lowers search engine A's results' ranking, which directly causes traffic loss for search engine A. For these reasons, a search term whitelist is maintained in search engine A.

However, it is very difficult to collect a complete search term whitelist in one iteration using ordinary log mining techniques. Therefore, if the search term whitelist is not expanded in real time, the search engine A can suffer from traffic loss.

Currently, when expanding the search term whitelist, typically system log analysis is performed. For example, at predefined intervals, the terms to be searched entered by users are analyzed using system log offline data, and determinations are made as to whether or not to add the terms to the search term whitelist. In this technique, because the search term whitelist is only expanded at the predefined intervals, timeliness is quite poor. Even if search popularity of a certain term to be searched is very high for a period of time, a strong likelihood exists that a user will be unable to access search engine A from search engine B to perform a search of the term to be searched resulting in a less satisfactory user experience and a loss of traffic on search engine A.

The above example merely describes an example in which the search system corresponds to a search engine.

In some embodiments, a method and a system for search term whitelist expansion are provided to perform more timely expansion of the search term whitelist, and thereby provide a more satisfactory user experience and reduce search system traffic loss.

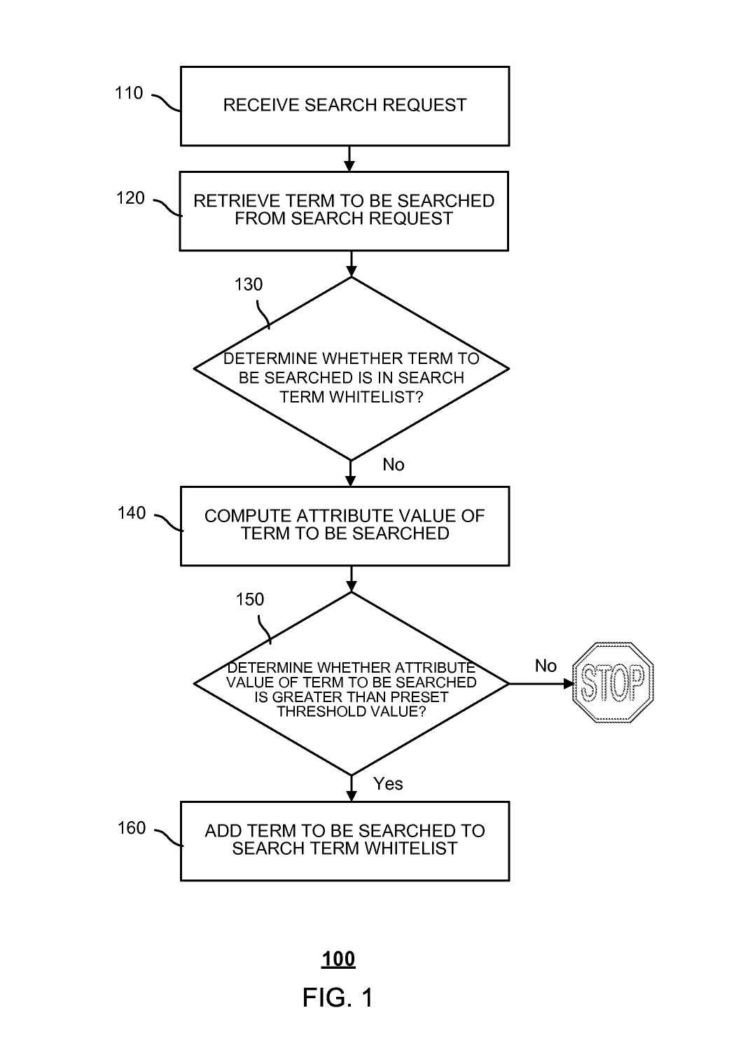

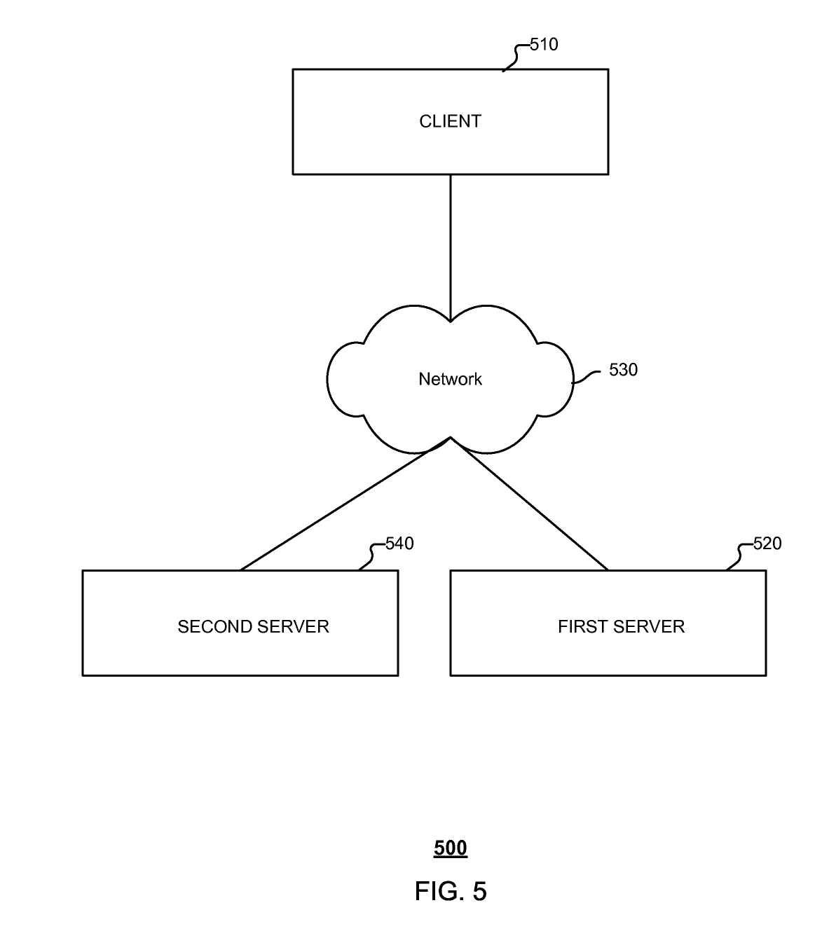

FIG. 1 is a schematic flow diagram of an embodiment of a process for search term whitelist expansion. In some embodiments, the process 100 is performed by a first search engine, such as server 520 of FIG. 5, and comprises:

In 110, the server receives a search request. The search request is used to instruct a search for information related to a term to be searched. In some embodiments, the search request is sent via an HTTP GET or HTTP POST message to the URL of the designated search engine according to the search engine's specification, such as “HTTP://www.google.com/search?q=guitar”, http://www.baidu.com/#wd=mp3&rsv_bp=0, etc.

In some embodiments, the search request originates from a first search system or the server, or the search request originates from a second search system or external server. For example, the first search system corresponds to a specified intrasite search engine that searches for specific content such as webpages, etc. on a particular website, while a second search engine corresponds to a general search engine that searches Internet content generally. An example of the intrasite search engine includes the commercial search engine on the 1688.com website (URL: http://s.1688.com/) which searches for products, producers, etc. on Alibaba®'s e-commerce platform. Examples of the general search engine include Baidu®, Google®, and Yahoo® search engines. In some embodiments, first or second search engines refer to systems such as server systems used to implement search functions.

In 120, the server retrieves a term to be searched from the search request.

In some embodiments, prior to performing operation 120, the server determines whether the search request includes a term to be searched; in the event that the search request does not include the term to be searched, expansion of the search term whitelist is not required, the process can be terminated directly, and a default search page is returned. In some embodiments, the default search result indicates that the search result is null. For example, the default search result is an error code (e.g., a 404 page not found error).

The parameter information, coding techniques, and encryption techniques included in terms to be searched of search requests originating from different search systems (for example, whether the search request originated from an intrasite search engine or a general search engine, and as an example, which general search engine the search request originated from) are typically different. As used herein, a search request is said to originate from a search engine when it is initially sent by a client device using a browser or other application to the search engine. A search request that is originated from one search engine can be forwarded by the originating search engine to a different search engine to obtain search results. For example, an HTTP redirect can be used to forward the search request, or a separate HTTP request can be constructed by the originating search engine and sent to the other search engine. Therefore, when the term to be searched is retrieved from a search request in the operation 120, the retrieval can also be performed based on the origin information of the search request. For example, in the event that the term to be searched in the search request that originated from search system A has undergone special encoding or encryption, the term to be searched is retrieved after performing the corresponding decoding or decryption of the term to be searched. In some embodiments, parameter information of the term to be searched corresponds to a Uniform Resource Locator (URL) parameter indicating identifier information used to extract the term to be searched. For example, in a search request originating from search system B and designating http://www.baidu.com/#wd=mp3&rsv_bp=0, the URL parameter identifying the search term is “wd.” In other words, the term to be searched is the value of the “wd” parameter following “wd=,” which is “mp3” in this example. Therefore, the search term is “mp3” in this example. Other search engines may designate the search term differently in the search request. For example, in the search query designating “HTTP://www.google.com/search?q=guitar,” the URL parameter indicating the search term is “q,” and the corresponding search term is “guitar.” Various search term formats can be used depending on implementation.

Because the search term whitelist can be used to limit the scope of usable search terms in searches originating from the second search system and being searched in the first search system, when expanding the search term whitelist, the corresponding expansion function should be capable of being triggered only when a search request transmitted by a second search engine other than the first search engine is received. At this time, prior to performing operation 120, the first search system determines whether the search request originated from a second search system. In the event that the search request originated from the second search system, operation 120 is performed. In the event that the search request did not originate from the second search system, this determination indicates that the search request originated from the first search engine, i.e., an intrasite search request, whereupon an intrasite search can be performed directly, and expansion of the search term whitelist is not needed, and the process is therefore terminated. In some embodiments, upon receipt of a search request (for example, a URL being accessed by the user), the first search system can determine whether this search request originated from a second search engine based on origin information included in the search request. For example, the first search engine at 1688.com may receive a request “http://www.1688.com/#origin=www.baidu.com&wd=mp3&rsv_bp=0” which indicates that the origin of the request is www.baidu.com. Other techniques of indicating the origin information can be used; for example, instead of the URL, the IP address of the originating search engine can be included in the request.

In 130, the server determines whether the term to be searched is in a search term whitelist. In the event that the term to be searched is not in the search term whitelist, control is passed to operation 140.

In some embodiments, the whitelist is a sorted list or table of search terms, and the term to be searched can be looked up in the list or table to determine whether the term is present in the whitelist. In the event that the term to be searched is in the search term whitelist, expanding the search term whitelist is not necessary, and the search of the term to be searched is performed and the search results are returned directly. But if the term to be searched itself is not already in the search term whitelist, a determination is made as to whether the search term whitelist is to be expanded, and control passes to operation 140.

Note that in the event that the term to be searched is not in the search term whitelist and the term to be searched originates from a second search system, the return of a default search page can also be performed. The default search page indicates that the search result is null.

In 140, the server computes an attribute value of the term to be searched.

In some embodiments, a determination as to whether the term to be searched is to be added to the search term whitelist is actually made based on a computation of the attribute value of the term to be searched. In addition, the attribute value of the term to be searched is related to a correlation between the term to be searched and the search results. Some examples of how to compute the attribute value are described below. Any computation techniques known to those of ordinary skill in the art can be employed. The computation technique of the attribute value is not limited to any particular technique.

In 150, the server determines whether the attribute value of the term to be searched is greater than or equal to a preset threshold value. In the event that the attribute value of the term to be searched is greater than or equal to the preset threshold value, control is passed to operation 160.

In the event that the attribute value of the term to be searched is greater than or equal to the preset threshold value, this indicates that the correlation between the term to be searched and the search results is relatively high, and that the term is to therefore be added to the search term whitelist in order to expand the search term whitelist, therefore operation 160 is performed. In the event that the attribute value of the term to be searched is less than the preset threshold value, this indicates that the correlation between the term to be searched and the search results is relatively poor. At this time, adding the term to be searched to the search term whitelist is not to be performed, and the process can be directly terminated. To conserve system workload, a tag can be associated with the term to be searched to indicate that the term is not whitelisted or a list of non-whitelisted terms can be established, so that within a period of time, whenever the same search term is retrieved, computing the attribute value of this search term is not performed. Instead, the result is returned that corresponds to the search term not being added to the search term whitelist.

The preset threshold value can be set based on a standard of relevance of the term to be searched and the search results, and reference can also be made to the scoring criteria of the second search engine with respect to the first search engine. One of ordinary skill in the art understands how a reference can be made to the scoring criteria of the second search engine with respect to the first search engine and will not be further described for conciseness.

In 160, the server adds the term to be searched to the search term whitelist.

In some embodiments, in the event that the attribute value of the term to be searched is greater than or equal to the preset threshold value, the term to be searched is added to the search term whitelist to expand the search term whitelist.

As described above, in some embodiments, expanding the search term whitelist based on offline data of the system log is not necessary. Instead, each time the first search system receives a search request, i.e., whenever the first search system is to search a term to be searched, a determination is made as to whether the search term whitelist is to be expanded, i.e., a determination is made as to whether the attribute value of the term to be searched is greater than or equal to a preset threshold value; in the event that the attribute value of the term to be searched is greater than or equal to the preset threshold value, the term to be searched is added to the search term whitelist and the search term whitelist is expanded. Therefore, the next time the term to be searched originating from the second search system is received, the search of the term to be searched by the first search system is no longer limited to the original whitelist, thereby expansion of the search term whitelist is achieved in a more timely manner. Moreover, in the event that the search popularity of a certain search term is very high for a certain time period, and the search term meets the standard for addition to the search term whitelist, then the search term will very quickly be added to the search term whitelist as users search the search term whitelist, greatly providing a more satisfactory user experience and reducing traffic loss on the first search engine.

The attribute value of the term to be searched relates to the correlation between the term to be searched and the search results. The specific computation technique of the attribute value of the term to be searched is not limited. Below, one example computation technique of the attribute value of the term is presented.

In the some embodiments, the attribute value of the term to be searched can be obtained based on the relevance of the product category/catalog (e.g., Sports) to which the term to be searched belongs to the term to be searched, the relevance of the first search results to the term to be searched, the number of the first search results, or any combination thereof.

In some embodiments, the first search results are retrieved through a search of the term to be searched in the first search system, and the first search results are used to compute an attribute value for the term to be searched. In the event that the search request originated from a second search system and the term to be searched is not in the search term whitelist, the first search results are not returned to the user and therefore are not displayed to the user.

The product category/catalog to which the term to be searched belongs is retrieved based on a landing page of the first search results. Because search results are typically ranked based on their relevancy and displayed according to their rankings, when multiple first search results are available, the landing page (e.g., first page) tends to include the most relevant results. In some embodiments, the first search system includes multiple product categories/catalogs (e.g., different categories such as sports, clothing, toys, etc. according to which search results are classified), and when the user initiates a search request and conducts a search in the first search system, the corresponding category is to be selected, and the first search system only returns search results for the search term entered by the user from within the category. For example, in the event that the user enters the search term “mobile telephone” in the “products” category, the first search system performs a search for “mobile telephone” in the “products” category. Thus, in some embodiments, the product category/catalog to which the term to be searched belongs can be determined based on the landing page of the first search results. Moreover, when calculating an attribute value of the term to be searched, the calculation can be based on the correlation between the category to which the term to be searched belongs and the term to be searched.

In some embodiments, prior to the calculating of the attribute value of the term to be searched, the term to be searched is also parsed to obtain at least one parsing result, attribute values are calculated for each parsing result, and an attribute value for the term to be searched as a whole is calculated based on attribute values of each of the parsing results (e.g., by computing the sum of the attribute values of the parsing results). Furthermore, the attribute value of the term to be searched as a whole can include two parts: an attribute value for the term itself, and an attribute value for the search results. In some embodiments, the attribute value of the term itself is determined based on the relevance of the category to which the term to be searched belongs, the relevance between the various parsing results obtained through parsing, position attributes of the various parsing results, etc. In addition, an attribute value of the search results refers to an attribute value related to the first search results using the term to be searched, and can be computed based on a relevance score of the first search results to the term to be searched, the number of first search results, etc.

In some embodiments, the attribute value is determined based at least in part on the number of the first search results. For example, a large number of first search results (e.g., a number of first search results exceeding a predefined threshold) tends to indicate that the term is highly relevant and will lead to a high attribute value.

In the event that a determination is made, based on the term to be searched itself, that the term to be searched is an unusable search term, then the attribute value does not have to be computed, and the term to be searched does not need to be added to the search term whitelist. In an example, prior to performing operation 160, the process 100 further comprises: the server determines as to whether the term to be searched satisfies filtering conditions used to filter unusable search terms; in the event that the term to be searched does not satisfy the filtering conditions used to filter unusable search terms, the server adds the term to be searched to the search term whitelist; in the event that the term to be searched satisfies the filtering conditions used to filter unusable search terms, the server omits adding the term to be searched to the search term whitelist, and the process is directly terminated. In some embodiments, the filtering conditions include: the term does not include specified characters (such as Chinese or English characters), the term includes illegal characters (e.g., words that are censored), the term has non-standard formatting of begin and end fields (e.g., telephone number appearing before or after the term), or any combination thereof. Other filtering conditions can be specified in other embodiments.

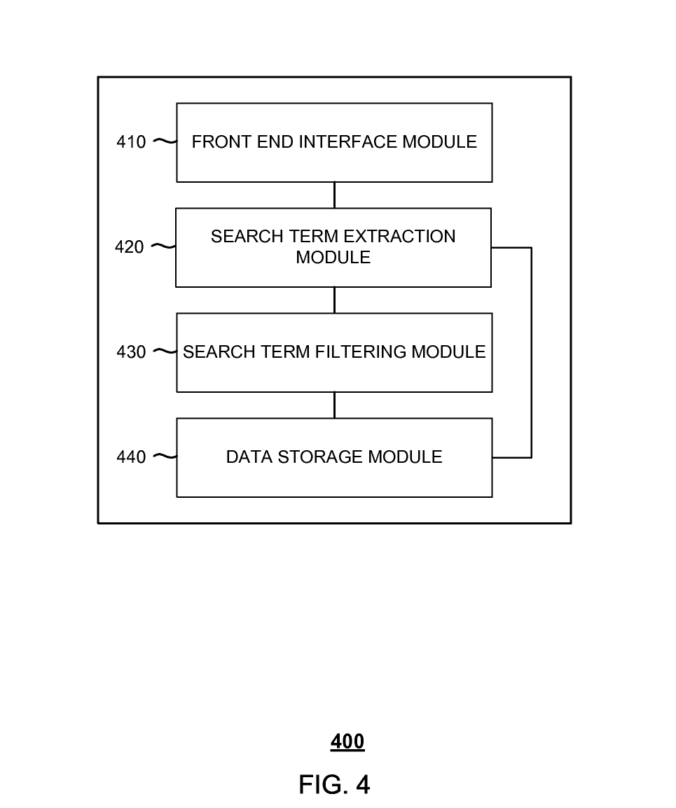

In some embodiments, as shown in FIG. 4 (to be discussed later), the first search system includes four modules: a front end interface module, a search term extraction module, a search term filtering module, and a data storage module. The search term whitelist is stored in the data storage module, the front end user interface module is used to perform operation 110, the search term extraction module is used to perform operations 120 and 130, and the search term filtering module is used to perform operations 140-160. Below, an example of a first search system including the above four modules describes a specific application scenario. In some embodiments, the description will use an example where the first search system is a commercial search engine of the 1688 website, and the second search system is a general search engine.

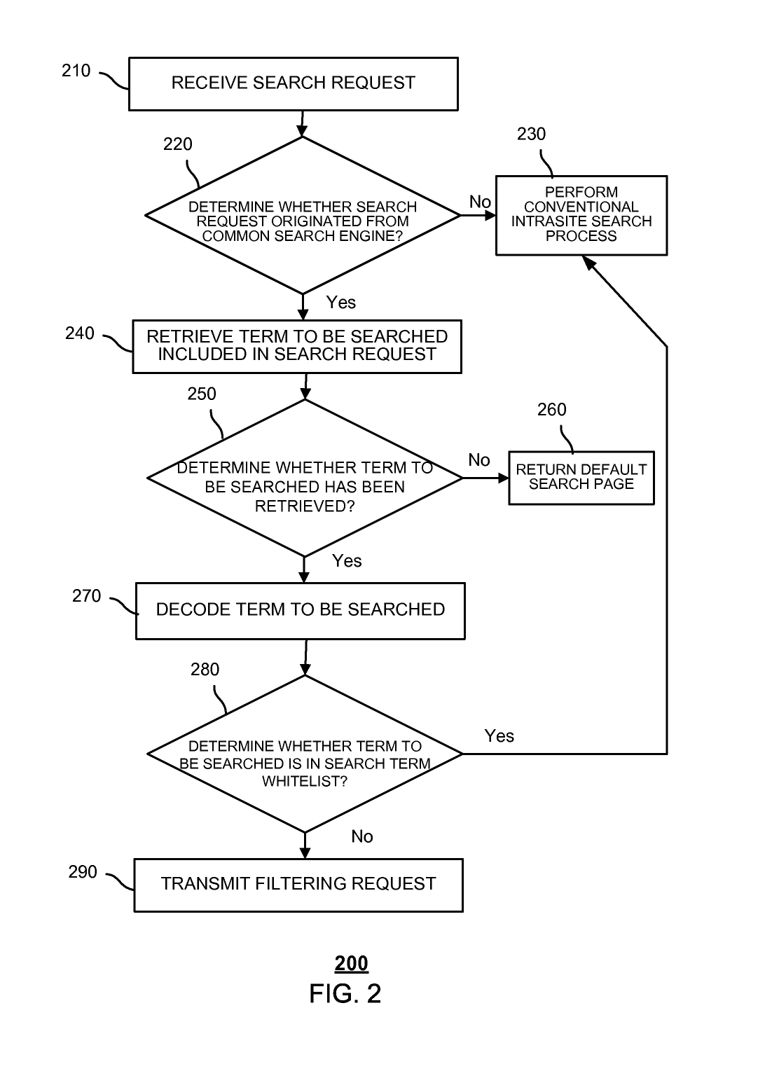

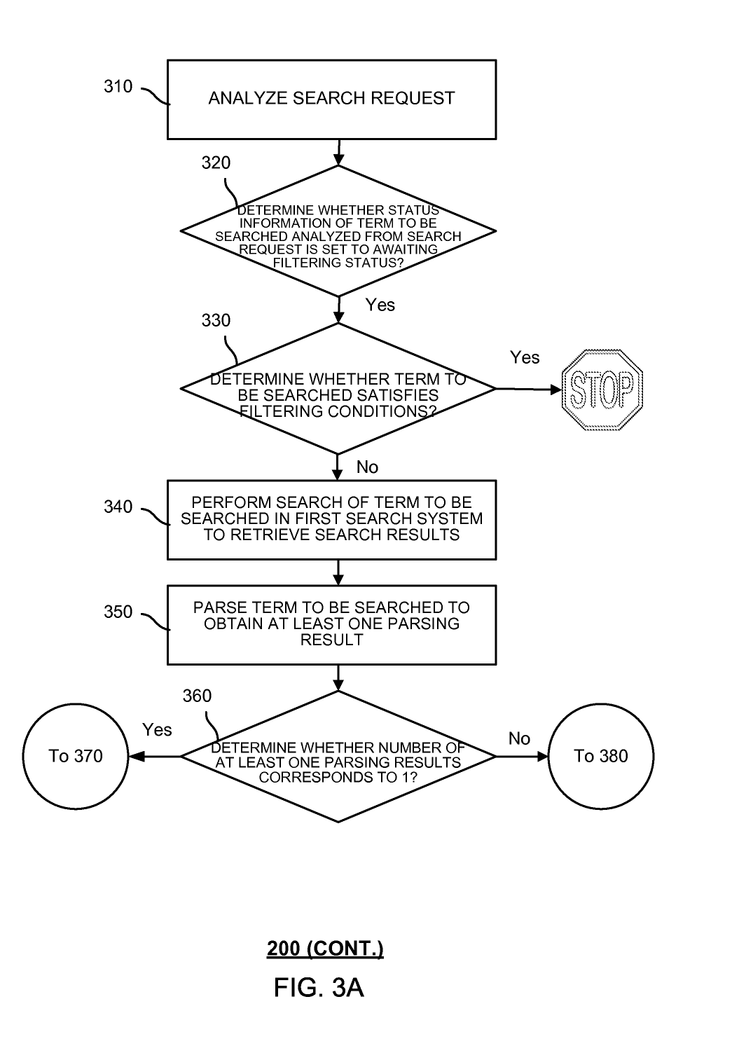

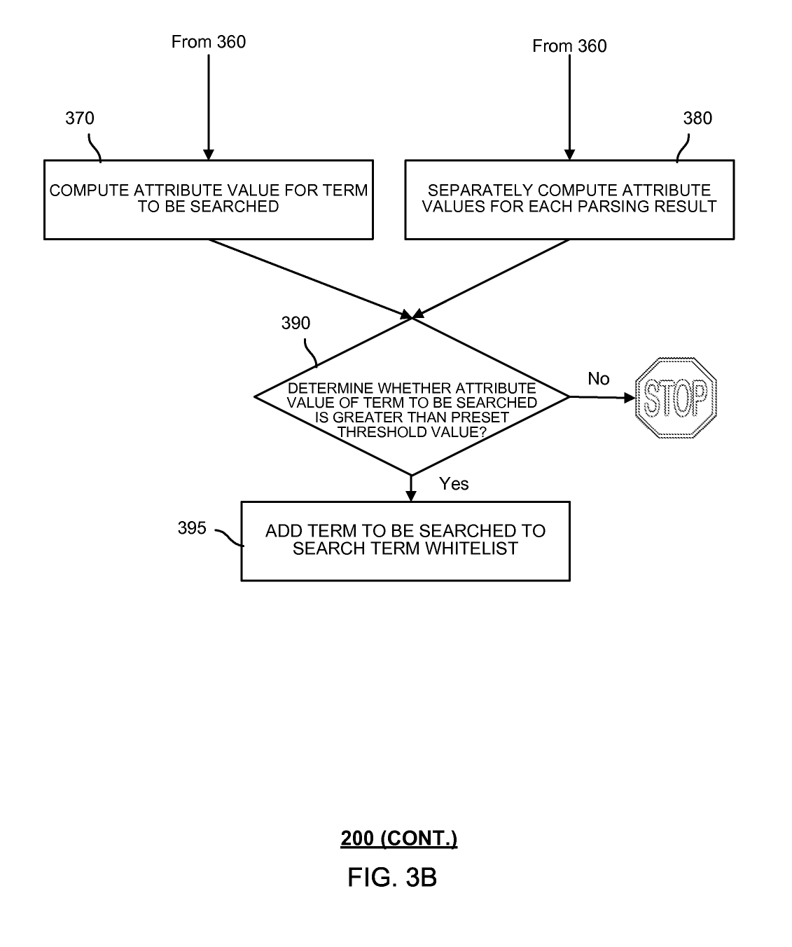

FIGS. 2, 3A and 3B are flowcharts of another embodiment of a process for search term whitelist expansion. In some embodiments, the process 200 is performed by a first search engine, such as first server 520 of FIG. 5. and comprises:

In 210, the front end interface module of the server receives a search request from a user, and transmits this search request to the search term extraction module. In some embodiments, the search request includes a URL being accessed by the user.

For example, the user clicks a search button in any search system, and as a result, the front end interface module receives the user's search request.

In 220, the search term extraction module of the server determines whether the search request originated from a general search engine based on origin information included in the search request. In the event that the search request did not originate from the general search engine, control is passed to operation 230; and in the event that the search request originated from the general search engine, control is passed to operation 240.

In 230, the search request is determined not to have originated from a general search engine, and instead a determination is made that the search request originated from the intrasite search engine such as the commercial search engine on the 1688.com website. In 230, the search term extraction module of the server performs a conventional intrasite search process. For example, after the term to be searched is retrieved, a search is performed in the commercial search engine on the 1688.com website and the process is terminated.

In 240, the search request is determined to have originated from the general search engine, and the search term extraction module of the server retrieves the term to be searched included in the search request based on the search request origin information.

For example, in 240, based on which general search engine the search request originated from, a determination is made of the URL parameter of the term to be searched, and the term to be searched is extracted from the search request based on this URL parameter.

In 250, the search term extraction module of the server determines whether the term to be searched has been retrieved.

In the event that the term to be searched has not been retrieved, control is passed to operation 260; and in the event that the term to be searched has been retrieved, control is passed to operation 270.

In 260, the search request has been determined to not include the term to be searched, therefore the search extraction module notifies the front end interface module to return a default search page and the process is terminated. In some embodiments, the default search page indicates that the search result is null.

In 270, the search request has been determined to include the term to be searched, therefore the search term extraction module performs further extracting, decoding, decryption, or a combination thereof of the term to be searched based on the origin information of the search request.

In 280, the search term extraction module determines whether the term to be searched is in a search term whitelist.

In the event that the term to be searched is in a search term whitelist, control is passed to operation 230; and in the event that the term to be searched is not in the search time whitelist, control is passed to operation 290. In some embodiments, the search term whitelist is read from the data storage module of the server.

In some embodiments, the data storage module is set up in a KV (Key Value) buffer. In some embodiments, the KV buffer corresponds to an LDB (level database) buffer. Because the volume of data in the search term whitelist can be relatively large, the data storage module can use hard disk buffer-based storage to ensure that no data losses occur due to a loss of power. Moreover, in most situations, the read operation is performed with respect to the search term whitelist, while the write operation occurs much less frequently. Therefore, in some embodiments, further optimization of the data storage module is possible to enhance the data storage module's reading performance.

In 290, a determination is made that the term to be searched is not in the search term whitelist. Therefore, a further determination is made as to whether the term to be searched is to be added to this search term whitelist. Thus, the search term extraction module of the server transmits a filtering request (e.g., an http request) to the search term filtering module. The filtering request includes the encoded term to be searched, status information for the term to be searched, origin information for the term to be searched, or any combination thereof. In some embodiments, the status information indicates that the term to be searched is set to awaiting filtering status, and the origin information indicates that the term to be searched originated from a general search engine. In some embodiments, the encoding technique is UTF-8 encoding.

Because the term to be searched is not in the search term whitelist, operation 290 can simultaneously notify the front end interface module to return the default search page.

Referring to FIGS. 3A and 3B, operation 310 is performed after operation 290 is complete.

In 310, upon receipt of the filtering request, the search term filtering module of the server analyzes the search request to retrieve the term to be searched, the origin information of the term to be searched, the status information of the term to be searched, or any combination thereof.

In 320, the search term filtering module determines whether the status information of the term to be searched analyzed from the search request is set to the awaiting filtering status. In the event that the status information of the term to be searched analyzed from the search request is set to the awaiting filtering status, control passes to operation 330.

In operation 320, in the event that a determination is made that the status information of the term to be searched analyzed from the search request is not set to the awaiting filtering status, this indicates that no determination is to be made here with respect to whether the term to be searched is to be added to the search term whitelist. Therefore, the search term filtering module can pass the term to be searched along to other modules for corresponding processing.

In 330, the search term filtering module determines whether the term to be searched satisfies the filtering conditions used to filter unusable search terms. In the event that the term to be searched satisfies the filtering conditions used to filter unusable search terms, the process is terminated; otherwise, control passes to operation 340.

In operation 330, successive determinations can be made as to whether the term to be searched satisfies the following conditions: contains no specified characters (such as Chinese or English characters), contains illegal characters, illegal formatting of begin and end fields, or any combination thereof. If one of the above conditions is satisfied, operation 340 is not executed and the process is terminated.

In 340, the search filtering module performs a search of the term to be searched in the first search system to retrieve search results, and obtains a product category to which the term to be searched belongs based on a landing page of the search results.

In 350, the search filtering module parses the term to be searched to obtain at least one parsing result (or at least one parsed term).

In 360, the search filtering module determines whether a number of the parsing results corresponds to 1. In the event that the number of the at least one parsing results corresponds to 1, operation 370 is performed. In the event that the number of the at least one parsing results does not equal 1, operation 380 is performed.

In some embodiments, an attribute value of the term to be searched is computed using various techniques based on the number of parsing results.

In 370, the term to be searched itself is an inseparable term, and the search term filtering module directly computes an attribute value for the term to be searched.

In some embodiments, the attribute value of the term to be searched includes an attribute value of the term itself and an attribute value of the search results. In some embodiments, the attribute value of the term itself relates to the relevance of the product category/catalog to which the term to be searched belongs to the term to be searched. In some embodiments, the attribute value of the search results relates to the relevance of the search results to the term to be searched and the number of search results.

In some embodiments, the relevance of the product category/catalog to which the term to be searched belongs to the term to be searched is related to whether the term to be searched belongs to the category to which the term to be searched belongs, or in other words, whether the category to which the term to be searched belongs matches the category to which the term to be searched belongs. For example, in the event that a determination is made in operation 340 that the category to which the term to be searched belongs corresponds to a “products” category, then in operation 370, a determination can be made as to whether an attribute value of the term to be searched is a product. In the event that the attribute value of the term to be searched is not the product category, the relevance is determined to be very low, and the process is terminated.

In 380, multiple parsing results have been obtained by parsing the term to be searched; the search term filtering module separately computes attribute values for each parsing result, and an attribute value for the term to be searched is obtained accordingly. For example, the attribute value for the term to be searched corresponds to a sum of the attribute values for the parsing results.

In some embodiments, the attribute value of each of the parsing results includes an attribute value of the term itself and an attribute value of the search results. The attribute value of the term itself can relate to the correlation and position attributes among the various parsing results. For example, the term appearing first has a higher weight than a term appearing second. In addition, the attribute value of the search results can relate to the relevance of the search results to the term to be searched and the number of search results.

In 390, the search term filtering module determines whether the attribute value of the term to be searched is greater than a preset threshold value. In the event that the attribute value of the term to be searched is greater than the preset threshold value, operation 395 is performed; otherwise, the process is terminated.

In some embodiments, the search term filtering module determines whether the sum of two attribute values (the attribute value of the term itself and the attribute value of the search results) is greater than a preset threshold value, or corresponding threshold values can be separately established for the attribute value of the term itself and the attribute value of the search results. In the event that either the attribute value of the term itself or the attribute value of the search results does not satisfy the corresponding preset threshold value, the process is terminated.

In 395, a determination is made that the correlation between the term to be searched and the search results is relatively high, therefore, the search term filtering module adds the term to be searched to the search term whitelist.

FIG. 2 illustrates the internal process of the search term extraction module, i.e., operations 210 to 290, while FIGS. 3A and 3B illustrate the internal process of the search term filtering module, i.e., operations 310 to 395.

FIG. 4 is a system diagram of an embodiment of a server for search term whitelist expansion. In some embodiments, the server 400 corresponds to a first search system. In some embodiments, the first search system is configured to perform process 100 of FIG. 1 and process 200 of FIGS. 2, 3A and 3B, and comprises a front end interface module 410, a search term extraction module 420, a search term filtering module 430, and a data storage module 440.

In some embodiments, the data storage module 440 is configured to store a search term whitelist. In some embodiments, the search term whitelist is used to limit the scope of usable search terms in searches originating from a second search system and being searched in the first search system.

In some embodiments, the front end interface module 410 is configured to receive search requests and transmit the search requests to the search term extraction module 420. In some embodiments, the search requests are used to instruct searches of information related to the term to be searched in the first search system.

In some embodiments, the search request originates from the first search system, or the search request originates from a second search system other than the first search system. For example, the first search system is a specified intrasite search engine, such as the commercial search engine on the 1688.com website (URL: http://s.1688.com/), and the second search engine is a general search engine, e.g., a search engine such as Baidu®, Google®, Yahoo®, etc. In some embodiments, the first or second search system refers to a search engine or other system used to perform the search function.

In some embodiments, the search term extraction module 420 is configured to extract the term to be searched from the search request, and determine whether the term to be searched is in the search term whitelist. In the event that the term to be searched is not in the search term whitelist, the term to be searched is transmitted to the search term filtering module 430.

Because the search term whitelist is used to limit the scope of usable search terms in searches originating from a second search system and being conducted in the first search system, the corresponding expansion function is only triggered when a search request transmitted by a second search engine other than the first search engine is received. Therefore, the search term extraction module 420 is further used, prior to the extraction of the term to be searched from the search request, to determine whether the search request originated from a second search system; retrieval of the term to be searched from the search request is performed in the event that the search request originated from a second search system. As an aspect, in the event that the search request did not originate from a second search system, the current search request originated from a first search engine, i.e., is an intrasite search request, whereupon only an intrasite search is to be performed, it is not necessary to expand the search term whitelist, and therefore the first search system omits performing the functions of the first search system. In some embodiments, upon receiving a search request (for example, a URL being accessed by a user), the search term extraction module 420 determines whether the search request originated from a second search engine based on the origin information included in the search request.

Prior to the extraction of the search term, the search term extraction module 420 can also determine whether the search request includes a term to be searched. In the event that the search request does not include the term to be searched, the expansion of the search term whitelist is not necessary, the process is terminated, and the default search page is returned. In some embodiments, the default search page indicates that the search result is null; for example, the default search page is an error page (e.g., a 404 page).

The parameter information, coding techniques, and encryption techniques included in terms to be searched of search requests originating from various search systems (for example, whether the search request originated from an intrasite search engine or a general search engine, and specifically which general search engine the search request originated from) are typically different. Therefore, when the search term extraction module 420 extracts the term to be searched from the search request, the search term extraction module 420 can also perform the extraction based on the origin information of the search request. For example, in a search request originating from search system A, in the event that the term to be searched has undergone special encoding or encryption, the search term extraction module 420 is to perform the corresponding decoding or decryption of the term to be searched to extract the term to be searched. In some embodiments, the parameter information of the term to be searched corresponds to a URL parameter that expresses identifier information used to extract the term to be searched.

In the event that the determination result of the search term extraction module 420 as to whether the term to be searched is in the search term whitelist is yes, the determination result indicates that the term to be searched itself is already in the search term whitelist, thus expanding the search term whitelist is not necessary, and the search of the term to be searched is performed and the search results returned directly. On the other hand, in the event that the determination result of the search term extraction module 420 is no, the determination result indicates that the term to be searched is not in the search term whitelist, whereupon a determination is made whether an expansion of the search term whitelist is to be performed, therefore the term to be searched is transmitted to the search term filtering module 430. In some embodiments, the search term extraction module 420 transmits the term to be searched based on a filtering request, and in this filtering request, a filtering status of the term to be searched is also labeled, thereby enabling the search term filtering module 430 to know that the term to be searched is to undergo a further determination as to whether the term to be searched is to be added to the search term whitelist.

In the event that the result of the determination by the search term extraction module 420 is no and the term to be searched originated from a second search system, the default search page can be returned. The default page can indicate that the search result is null.

The search term filtering module 430 is configured to compute an attribute value of the term to be searched and determine whether the attribute value of the term to be searched is greater than a preset threshold value. In the event that the attribute value of the term to be searched is greater than the preset threshold value, the term to be searched is added to the search term whitelist.

When the determination result as to whether the attribute value of the search term is greater than the preset threshold value is yes, the determination result indicates a relatively high correlation between the term to be searched and the search results. Accordingly, the term is to be added to the search term whitelist to expand the search term whitelist. In the event that the determination result is no, the determination result indicates a relatively poor correlation between the term to be searched and the search results, whereupon the term to be searched does not need to be added to the search term whitelist, and the search term filtering module 430 is used to terminate the function. At the same time, to conserve system workload, a tag can be added to the search term indicating that within a period of time, whenever the same first search term is retrieved, computation of the attribute value of the first search term is not required. Instead, the result that the search term is not being added to the search term whitelist is returned.

In some embodiments, the preset threshold value can be set based on the correlation between the term to be searched and the search results, and reference can also be made to the second search engine's scoring criteria with respect to the first search engine.

As discussed above, the expansion of the search term whitelist based on the offline data of the system log is not necessary. Each time the first search system receives a search request, i.e., whenever the first search system is to search a term to be searched, a determination is made as to whether the search term whitelist is to be expanded, i.e., a determination is made as to whether the attribute value of the term to be searched is greater than the preset threshold value. In the event that the attribute value of the term to be searched is greater than the preset threshold value, the term to be searched is added to the search term whitelist and an expansion of the search term whitelist is performed. Therefore, the next time a term to be searched originating from the second search system is received, the search of the term to be searched by the first search system is no longer limited, thereby expansion of the search term whitelist is achieved more timely. Moreover, in the event that the search popularity of a certain search term is very high for a certain time period and the search term meets the requirements for addition to the search term whitelist, the search term can be very quickly added to the search term whitelist as users search the search term whitelist, greatly increasing satisfaction of the user experience and reducing traffic loss on the first search engine.

The attribute value of the term to be searched relates to the correlation between the term to be searched and the search results. The computation technique of the correlation between the term to be searched and the search results is not limited. Below is an example of one optional computation technique.

In some embodiments, the attribute value of the term to be searched is obtained based on the following parameters: the relevance of the product category/catalog to which the term to be searched belongs to the term to be searched, the relevance of the first search results to the term to be searched, the number of the first search results, or any combination thereof.

In some embodiments, the first search results are retrieved through a search of the term to be searched in the first search system. In some embodiments, the first search results are used to compute the attribute value of the term to be searched. In the event that the search request originated from a second search system and the term to be searched is not in the search term whitelist, the first search results are not returned to the user, and are therefore not displayed to the user.

The category to which the term to be searched belongs is extracted based on the landing page of the first search results. In some embodiments, the first search system includes multiple categories, therefore, in the event that the user initiates a search request and conducts a search in the first search system, the corresponding category is to be selected, and ultimately, the first search system only returns search results for the search term entered by the user from within this category. Thus, in some embodiments, the category to which the term to be searched belongs is determined based on the landing page of the first search results. Moreover, when computing the attribute value of the term to be searched, the computation can be based on the correlation between the category to which the term to be searched belongs and the term to be searched.

In some embodiments, prior to computing the attribute value of the term to be searched, the term to be searched is also parsed to obtain at least one parsing result, attribute values can be computed for each parsing result, and finally, an attribute value for the term to be searched as a whole can be computed based on the attribute values of each of the parsing results. Furthermore, the attribute value of the term to be searched as a whole can include two parts: an attribute value for the term itself and an attribute value for the search results. In some embodiments, the attribute value of the term refers to an attribute value related to the term to be searched, and can relate to the relevance of the product category/catalog to which the term to be searched belongs to the term to be searched, the relevance between the various parsing results obtained through parsing, position attributes of the various parsing results, etc. The attribute value of the search results relates to an attribute value related to the first search results using the term to be searched, and can relate to the relevance of the first search results to the term to be searched, the number of first search results, etc.

In the event that a determination is made based on the term to be searched as to whether the term to be searched is an unusable search term, then the computation of the attribute value of the term to be searched is not required, and a determination can be made that adding the term to be searched to the search term whitelist is not necessary. The search term filtering technique is further configured, prior to executing the addition of the term to be searched to the search term whitelist, to determine whether the term to be searched satisfies the filtering conditions used to filter unusable search terms. The addition of the term to be searched to the search term whitelist is performed in the event that the determination result is no. In the event that the determination result is yes, the addition of the term to be searched to the search term whitelist is not performed, and the search term filtering module can stop the corresponding functions. In some embodiments, the filtering conditions include: contains no Chinese or English characters, contains illegal characters, illegal formatting of begin and end fields, or any combination thereof.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

FIG. 5 is a diagram of an embodiment of a system for search term whitelist expansion. In some embodiments, the system 500 includes a client 510 connected to a first server or first search system 520 and a second server or second search system 540 via a network 530.

For example, the first search system 520 corresponds to a specified intrasite search engine that searches for specific content such as webpages, etc. on a particular website, while the second search system 540 corresponds to a general search engine that searches Internet content generally. An example of the intrasite search engine includes the commercial search engine on the 1688.com website (URL: http://s.1688.com/) which searches for products, producers, etc. on Alibaba®'s e-commerce platform. Examples of the general search engine include Baidu®, Google®, or Yahoo® search engines.

In some embodiments, a search request is sent by the client 510. The search request is used to instruct a search for information related to a term to be searched, and the search request can be sent to the first server directly or received by the second server which forwards it to the first server. First server 520 further retrieves the term to be searched from the search request, determines whether the term to be searched is in a search term whitelist, and in the event that the term to be searched is not in the search term whitelist: computes an attribute value of the term to be searched, determines whether the attribute value of the term to be searched is greater than a preset threshold value, and in the event that the attribute value of the term to be searched is greater than the preset threshold value, adds the term to be searched to the search term whitelist. In some embodiments, the search term whitelist is used to limit the scope of usable search terms in searches that originate from a second search system or second server 540 and are being searched in the first server or the first search system 520.

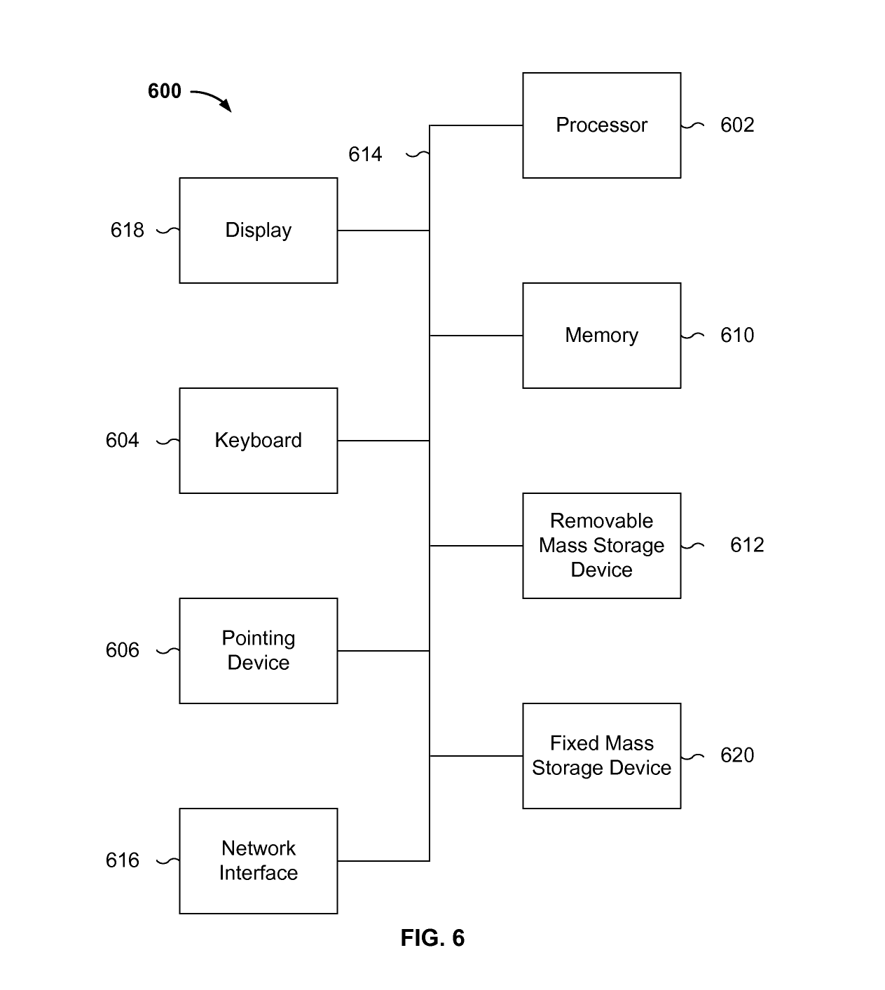

FIG. 6 is a functional diagram illustrating an embodiment of a programmed computer system for search term whitelist expansion. As will be apparent, other computer system architectures and configurations can be used to expand a search term whitelist. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618).

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data, and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or uni-directionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612 and 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a search request, the search request being used to instruct a search in a first search system for information related to a term to be searched;
retrieving the term to be searched from the search request;
determining whether the term to be searched is in a search term whitelist; and
in the event that the term to be searched is not in the search term whitelist:
computing an attribute value of the term to be searched;
determining whether the attribute value of the term to be searched is greater than a preset threshold value; and
in the event that the attribute value of the term to be searched is greater than the preset threshold value, adding the term to be searched to the search term whitelist.

2. The method as described in claim 1, further comprising: omitting returning search results corresponding to the term to be searched in the event that the term to be searched is not in the search term whitelist.

3. The method as described in claim 1, further comprising: returning one or more search results corresponding to the term to be searched in the event that the term to be searched is in the search term whitelist.

4. The method as described in claim 1, further comprising:
prior to the retrieving of the term to be searched from the search request:
determining whether the search request originated from the second search system; and
in the event that the search request originated from the second search system, performing the retrieving of the term to be searched from the search request.

5. The method as described in claim 4, further comprising:
in the event that the term to be searched is not in the search term whitelist, returning an indication of a null search result.

6. The method as described in claim 1, wherein:
the computing of the attribute value of the term to be searched is based on a relevance of a category to which the term to be searched belongs to the term to be searched, a relevance of first search results to the term to be searched, a number of the first search results, or any combination thereof, the first search results being retrieved through searches in the first search system of the term to be searched, and the category to which the term to be searched belongs being retrieved based on landing pages of the first search results.

7. The method as described in claim 1, further comprising:
prior to the adding of the term to be searched to the search term whitelist:
determining whether the term to be searched satisfies a filtering condition used to filter unusable search terms; and
in the event that the term to be searched does not satisfy the filtering condition used to filter unusable search terms, performing the adding of the term to be searched to the search term whitelist.

8. The method as described in claim 5, wherein the filtering condition includes: the term to is be searched includes no specified characters, the term to be searched includes non-standard formatting of begin and end fields, or a combination thereof.

9. The method as described in claim 1, wherein the second search system corresponds to a general search engine.

10. The method as described in claim 1, wherein the first search system corresponds to an intrasite search engine.

11. A first search system, comprising:
at least one processor configured to:
receive a search request, the search request being used to instruct a search in the first search system for information related to a term to be searched;
retrieve the term to be searched from the search request;
determine whether the term to be searched is in a search term whitelist; and
in the event that the term to be searched is not in the search term whitelist:
compute an attribute value of the term to be searched;
determine whether the attribute value of the term to be searched is greater than a preset threshold value; and
in the event that the attribute value of the term to be searched is greater than the preset threshold value, add the term to be searched to the search term whitelist; and
a memory coupled to the at least one processor and configured to provide the at least one processor with instructions.

12. The first search system as described in claim 11, wherein the at least one processor is further configured to: omit returning search results corresponding to the term to be searched in the event that the term to be searched is not in the search term whitelist.

13. The first search system as described in claim 11, wherein the at least one processor is further configured to: return one or more search results corresponding to the term to be searched in the event that the term to be searched is in the search term whitelist.

14. The first search system as described in claim 11, wherein the at least one processor is further configured to:
prior to the retrieving of the term to be searched from the search request:
determine whether the search request originated from the second search system; and
in the event that the search request originated from the second search system, perform the retrieving of the term to be searched from the search request.

15. The first search system as described in claim 14, wherein the at least one processor is further configured to:
in the event that the term to be searched is not in the search term whitelist, return an indication of a null search result.

16. The first search system as described in claim 11, wherein the computing of the attribute value of the term to be searched is based on a relevance of a category to which the term to be searched belongs to the term to be searched, a relevance of first search results to the term to be searched, a number of the first search results, or any combination thereof, the first search results being retrieved through searches in the first search system of the term to be searched, and the category to which the term to be searched belongs being retrieved based on landing pages of the first search results.

17. The first search system as described in claim 11, wherein the at least one processor is further configured to:
prior to the adding of the term to be searched to the search term whitelist:
determine whether the term to be searched satisfies a filtering condition used to filter unusable search terms; and
in the event that the term to be searched does not satisfy the filtering condition used to filter unusable search terms, perform the adding of the term to be searched to the search term whitelist.

18. The first search system as described in claim 17, wherein the filtering condition includes: the term to be searched includes no specified characters, the term to be searched includes illegal formatting of begin and end fields, or a combination thereof.

19. The first search system as described in claim 11, wherein the second search system is a general search engine.

20. The first search system as described in claim 11, wherein the first search system corresponds to an intrasite search engine.

21. A computer program product being embodied in a tangible non-transitory computer readable storage medium and comprising computer instructions for:
receiving a search request, the search request being used to instruct a search in a first search system for information related to a term to be searched;
retrieving the term to be searched from the search request;
determining whether the term to be searched is in a search term whitelist; and
in the event that the term to be searched is not in the search term whitelist:
computing an attribute value of the term to be searched;
determining whether the attribute value of the term to be searched is greater than a preset threshold value; and
in the event that the attribute value of the term to be searched is greater than the preset threshold value, adding the term to be searched to the search term whitelist.
